(19) United States
(12) Patent Application Publication
(10) Pub. No.: US 2010/0267251 A1
(43) Pub. Date: Oct. 21, 2010

(54) CABLE MANAGEMENT SYSTEM

(76) Inventor: Kenneth A. Phu, Westwood, MA (US)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 12/759,032

(22) Filed: Apr. 13, 2010

Related U.S. Application Data
(60) Provisional application No. 61/170,169, filed on Apr. 17, 2009.

(51) Int. Cl. H01R 29/00

(52) U.S. Cl. 439/49

(57) ABSTRACT

A cable management system. The system has the following: (a) a computer or network device having a plurality of first communication connectors, (b) one or more adapters having a plurality of second communication connectors and a plurality of third communication connectors, and (c) a plurality of patch cables. Each of the plurality of first connectors has an assigned corresponding connector among the plurality of second connectors. Each of the plurality of second connectors has an assigned corresponding connector among the plurality of third connectors. Each of the plurality of third connectors has an assigned corresponding connector among the plurality of patch cables. The one or more adapters is adapted to being connected to or being removed from the device. The first connectors are adapted to being connected to and in electrical connection with the plurality of second connectors or being disconnected therefrom. The plurality of patch cables are adapted to being connected to or removed from the one or more adapters. The plurality of patch cables are adapted to being connected to and in electrical connection with the plurality of third connectors or being disconnected therefrom.

### CROSS-REFERENCE TO A RELATED APPLICATION

The present application claims priority based upon U.S. Provisional Application No. 61/170,169, filed Apr. 17, 2009, which is incorporated herein in its entirety.

### BACKGROUND OF THE INVENTION

1. Field of the Invention

The present invention relates to a cable management system. The present invention further relates to a cable management system that eliminates the need for plugging and unplugging patch cables when a computer or network device is replaced or changed.

2. Description of the Prior Art

Communication closets commonly serve to interconnect computer networks of businesses and institutions. Communication closets typically have a patch panel and one or more communication or network devices, such as a network switch. The patch panel itself may be located within the closet or may be connected to the closet via a data jack located therein. A computer or network device is connected to the patch panel or a data jack therefor via one or more patch cables. The communication or network device may then be connected to other devices, such as those which provide it with access to other locations, including the World Wide Web.

As the number of connections to patch panels has increased, so has the number of patch cables from the patch panels to the network switches. In some instances, the number of patch cables has become unwieldy and has resulted in excessive entanglement, which can render difficult access to the communication or network device. Also, when a network switch fails, the replacement switch must be connected to the patch cables in the same manner configuration as the old switch. A large number of patch cables renders difficult the identification of specific cords and the location of the point of connection or plug-in.

Current systems for cable managing patch cables are directed primarily to improving the aesthetic appearance of patch cables, e.g., bundling of cables, and do not address the problem of identification of specific cables and the location of points of connection or plug-in. It would be desirable to have a cable management system that would eliminate the need for plugging and unplugging of individual patch cables when the communication or network device is replaced or exchanged.

### SUMMARY OF THE INVENTION

According to the present invention, there is provided a cable management system. The system has the following: (a) a computer or network device having a plurality of first communication connectors, (b) one or more adapters having a plurality of second communication connectors and a plurality of third communication connectors, and (c) a plurality of patch cables. The plurality of first connectors has an assigned corresponding connector among the plurality of second connectors. Each of the plurality of second connectors has an assigned corresponding connector among the plurality of third connectors. Each of the plurality of third connectors has an assigned corresponding patch cable among the plurality of patch cables. The one or more adapters is adapted to being connected to or being disconnected from the device. The first connectors are adapted to being connected to and in electrical connection with the plurality of second connectors or being removed therefrom. The plurality of patch cables are adapted to being connected to or removed from the one or more adapters. The plurality of patch cables are adapted to being connected to and in electrical connection with the plurality of third connectors or being removed therefrom.

### DESCRIPTION OF THE FIGURES

FIG. 1 is a perspective view of an embodiment of a cable management system according to the present invention.

FIG. 2 is a perspective view of another embodiment of a cable management system according to the present invention.

FIG. 3 is a perspective view of still another embodiment of a cable management system according to the present invention.

FIG. 4 is a perspective, exploded view of an embodiment of the system of FIG. 1 with one array of patch cables depicted.

FIG. 5 is a perspective view of a communication or network device with an adapter connected thereto useful in the systems of FIGS. 1 to 3.

FIG. 6 is a perspective view of the adapter of the systems of FIGS. 1 to 3.

FIG. 7 is a front view of the adapter of FIG. 6.

FIG. 8 is a rear view of the adapter of FIG. 6.

FIG. 9 is a left, cross-sectional side view of the adapter of FIG. 6 along line 9-9.

FIG. 10 is an exploded view of an upper portion of the view of the adapter shown in FIG. 9.

### DETAILED DESCRIPTION OF THE INVENTION

The present invention provides a cable management system for addressing the problem of identification of specific patch cables and the location of points of connection or plug-in. The present invention provides a cable management system that eliminates the need for plugging and unplugging, i.e., connected and disconnected, of individual patch cables when a device is exchanged or replaced.

The present invention provides an adapter that affords easy connection and disconnection of patch cables from a communication or network device. The adapter can be disconnected from the device, the device exchanged or replaced, and the adapter re-connected to the exchanged or replaced device. During the disconnection/re-connection process, the patch cables remain connected to the adapter. The only component that is disconnected from and re-connected to the device is the adapter.

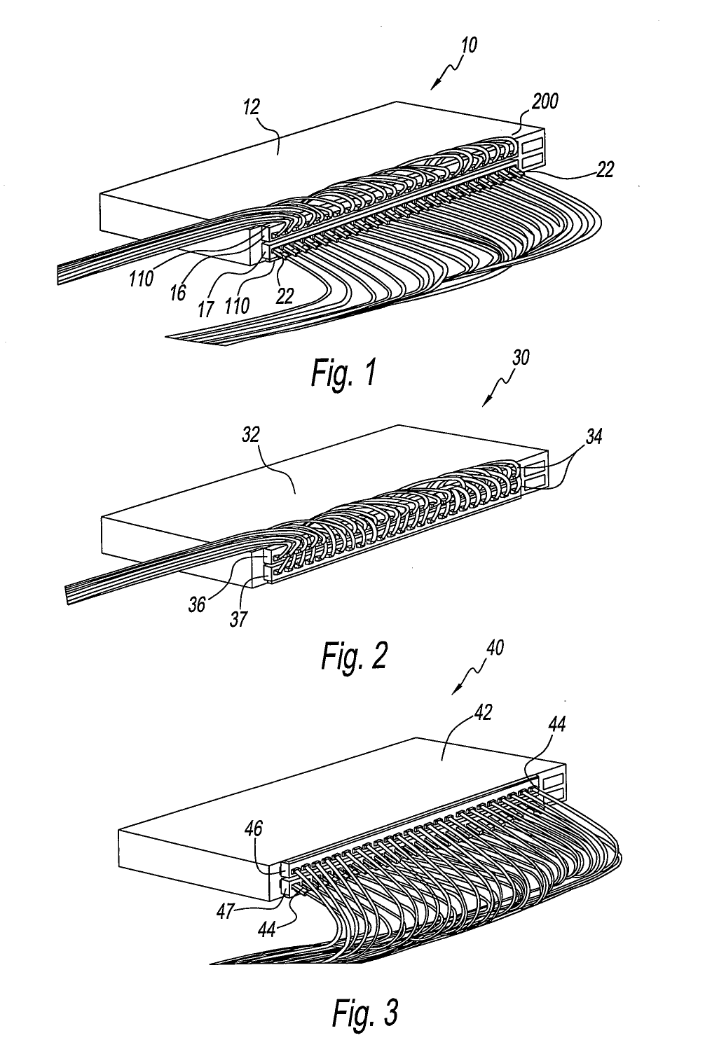

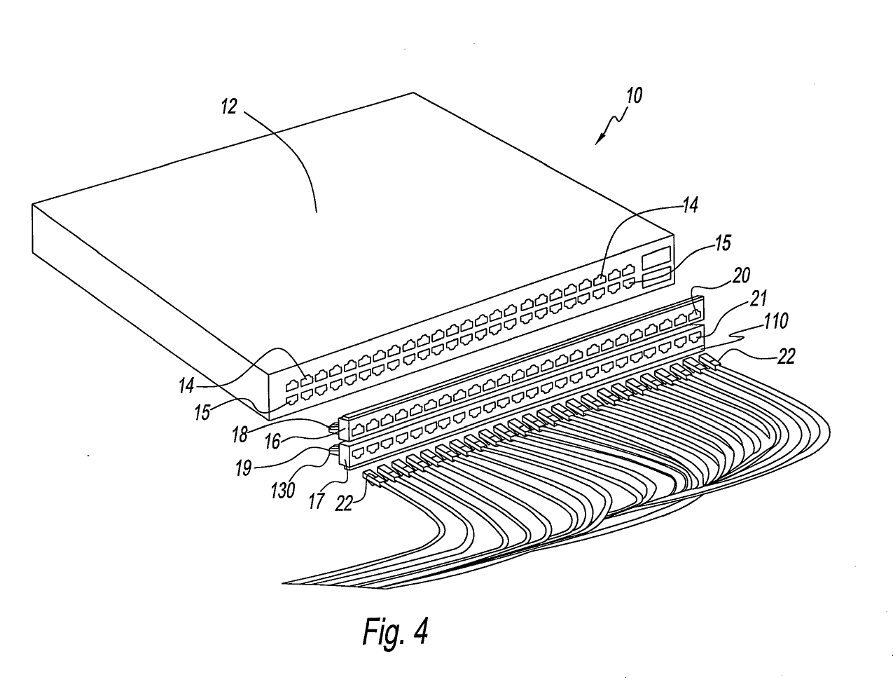

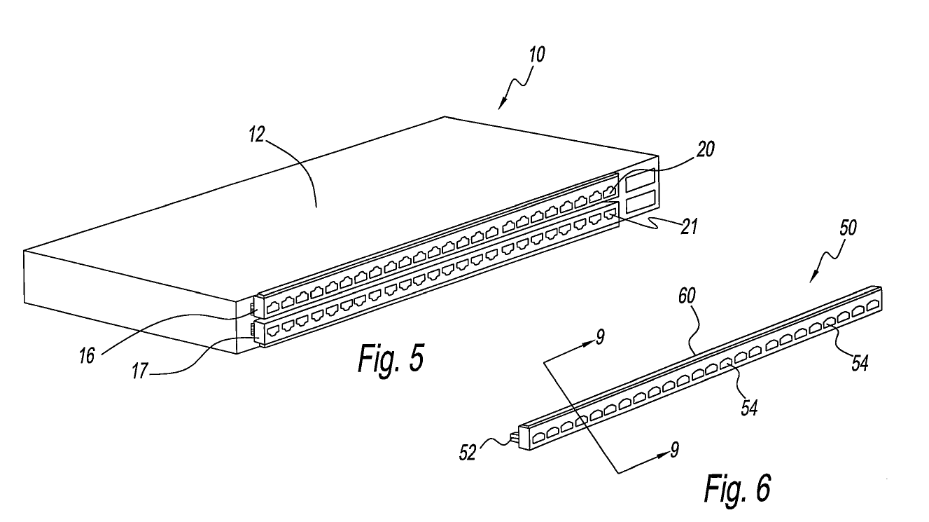

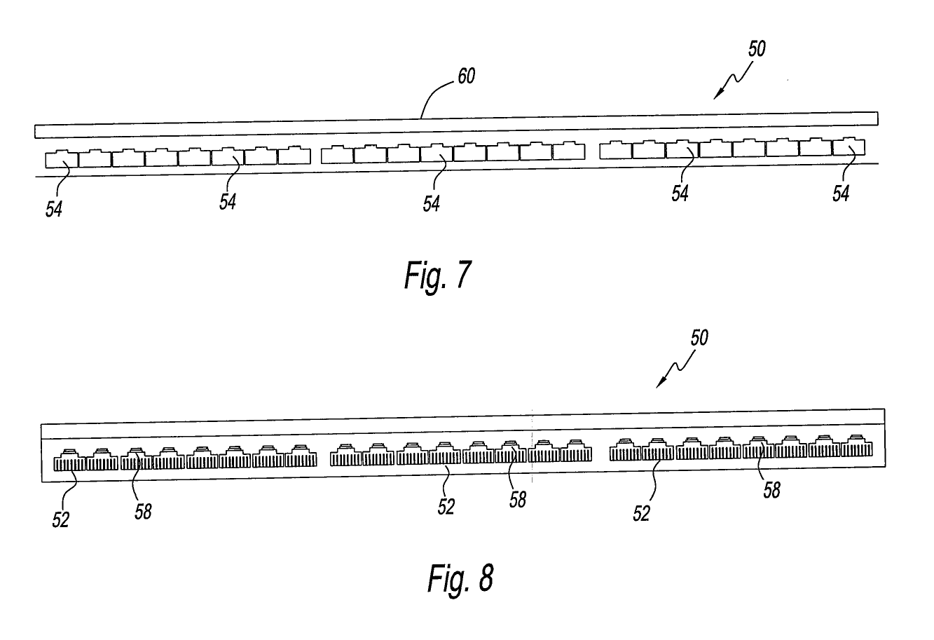

An embodiment of the cable management system is shown in FIGS. 1 and 4 and is generally referenced by the numeral 10. System 10 has the following: (a) a computer or network device 12 having a plurality of first communication connectors 14 and 15, (b) adapters 16 and 17 having a plurality of second communication connectors 18 and 19 and a plurality of third communication connectors 20 and 21, and (c) a plurality of patch cables 22. Each of the plurality of first connectors 14 and 15 has an assigned corresponding connector among the plurality of second connectors 18 and 19. Each of the plurality of second connectors 18 and 19 has an assigned corresponding connector among the plurality of third connectors 20 and 21. Each of the plurality of third connectors 20 and 21 has an assigned corresponding connector among the plurality of patch cables 22. Adapters 16 and 17 are adapted to being connected to and being disconnected from device 12. First connectors 14 and 15 are adapted to being connected to and in electrical connection with the plurality of second connectors 18 and 19 and being disconnected therefrom. The plurality of patch cables 22 are adapted to being connected to or disconnected from adapters 16 and 17. The plurality of patch cables 22 are adapted to being connected to and in electrical connection with the plurality of third connectors 20 and 21 or being removed therefrom.

Another embodiment of the cable management system is shown in FIG. 2 and is generally referenced by the numeral 30. System 30 has a computer or network device 32, adapters 36, and a plurality of patch cables 34. The embodiment in FIG. 2 differs from the embodiment in FIG. 1 in that the patch cables are routed entirely from above adapters 36 instead of above and below.

Another embodiment of the cable management system is shown in FIG. 3 and is generally referenced by the numeral 40. System 40 has a computer or network device 42, adapters 46, and a plurality of patch cables 44. The embodiment in FIG. 3 differs from the embodiment in FIG. 1 in that patch cables 44 are routed entirely from below adapters 46 instead of above and below.

Computer or network device 12 may include any known in the art, such as a network switch or a telecommunications component that provides digital telephone access. Preferably, device 12 is a network switch. A network switch is useful, for example, for providing a computer connection to a network (not shown) or to the World Wide Web (not shown) and would be in electrical communication therewith.

The plurality of first connectors 14 can be male or female configuration but preferably of female configuration. Most preferably, first connectors 14 take the form of ports as shown in FIGS. 1 and 4. The plurality of second connectors 18 and 19 can be of male or female configuration but preferably are of male configuration as shown in FIGS. 1 and 4. The plurality of third connectors 20 and 21 can be male or female configuration but preferably are of female configuration. Most preferably, third connectors 21 and 21 take the form of ports as shown in FIGS. 1 and 4. The plurality of patch cables 22 can be male or female configuration but preferably are of male configuration as shown in FIGS. 1 and 4. Preferred male connectors include RJ45 and RJ12 connectors.

Adapters 16 and 17 are adapted to be connected to or disconnected from device 12 and are adapted to being in electrical connection therewith when connected. FIGS. 1 and 4 depict an embodiment with two adapters, but embodiments with a single adapter or three or more adapters are also within the scope of the invention. Given that the arrangement of the plurality of first connectors 14 and 15 on device 12 takes the form of a linear array, the plurality of second connectors 18 and 19 on adapters 16 and 17 will likewise take on the arrangement of linear arrays. When first connectors on a device take the form of a different arrangement or configuration, such as circular, semicircular, or triangular, the second connectors of the adapter will take on the same arrangement or configuration.

The plurality of patch cables can be routed from various directions to connect to the adapter. For instance, the plurality of patch cables 22 is routed from both above and below adapters 16 and 17 in the embodiment depicted in FIG. 1. Further for instance, the plurality of patch cables 34 is routed from above adapters 36 and 37 in the embodiment depicted in FIG. 2. Still further for instance, the plurality of patch cables 44 is routed from below adapters 46 and 47 in the embodiment depicted in FIG. 3. Routing of patch cables entirely from above or below permits easier release of an adapter(s) from a device. A preferred patch cable is a CAT cable.

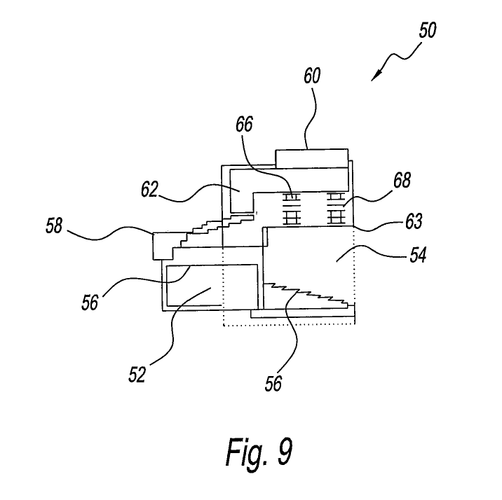

In a preferred embodiment, there is shown in FIG. 9 a cross-section of an adapter generally referenced by the numeral 50. Adapter 50 has second connectors 52 and third connectors 54. Second connectors 52 take the form of male connectors and third connectors 54 take the form of ports. Second connectors 52 are adapted to be connected to female connectors or ports in a device (not shown in FIG. 9). Third connectors 54 are adapted to be receive male connectors in the form of patch cables (not shown in FIG. 9). Adapter 50 has copper wiring 56 to provide electrical connection from patch cables to the device. Adapter 50 has a locking tab 58 in the form of a plastic tab that locks a patch cable within adapter 50 when the patch cable is inserted. When a release bar 60 is pressed, a release profile 62 is actuated to press down towards a receiving profile 63 onto tab 58, which allows adapter 50 to simultaneously disconnect from the device along second connectors 52. After the device has been changed, adapter 50 can be simultaneously reconnected to the new device along second connectors 52.

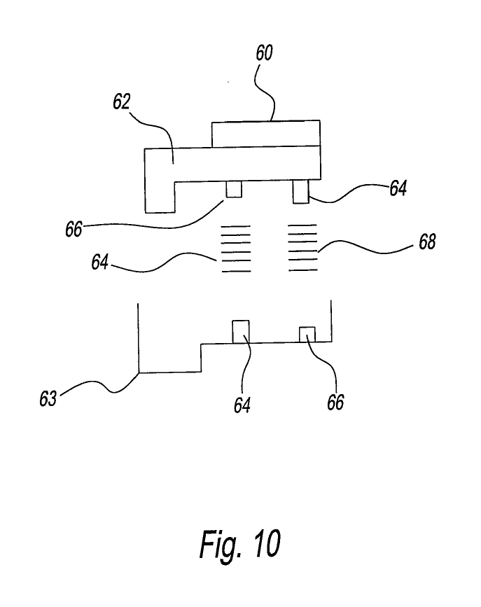

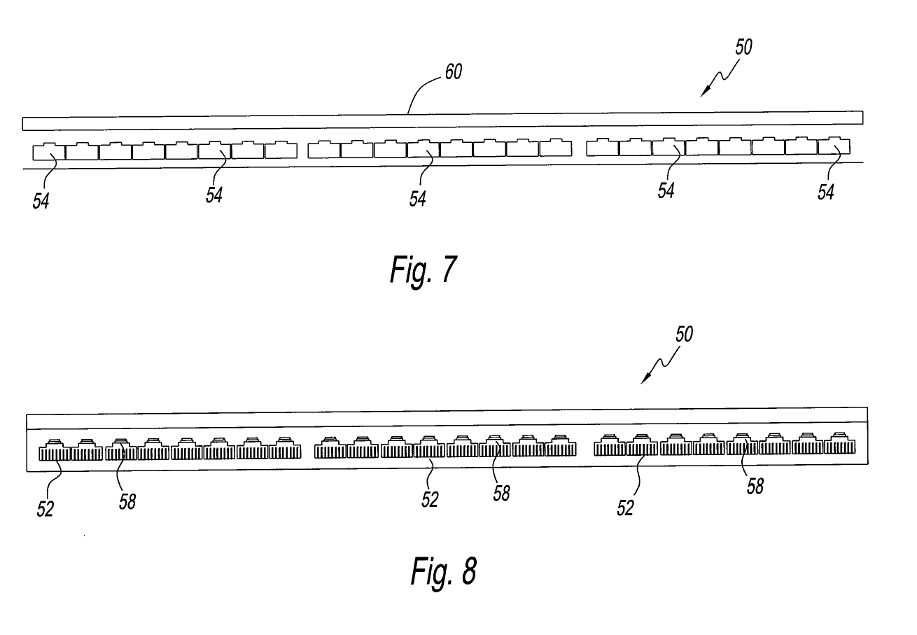

FIG. 10 shows an exploded view of some of the components of the release mechanism of adapter 50 shown in the upper portion of FIG. 9. Adapter 50 has two pairs of opposing long and short pegs 64 and 66, respectively, which actuate inside twin springs 68 when the release mechanism of adapter 50 is locked and unlocked. Springs 68 provide resistance to depression of release bar 60.

It should be understood that the foregoing description is only illustrative of the present invention. Various alternatives and modifications can be devised by those skilled in the art without departing from the invention. Accordingly, the present invention is intended to embrace all such alternatives, modifications and variances which fall within the scope of the appended claims.

What is claimed is:

1. A cable management system, comprising:
a computer or network device having a plurality of first communication connectors;
one or more adapters having a plurality of second communication connectors and a plurality of third communication connectors, wherein each of the plurality of first connectors has an assigned corresponding connector among the plurality of second connectors, wherein each of the plurality of second connectors has an assigned corresponding connector among the plurality of third connectors; and
a plurality of patch cables,
wherein the one or more adapters is adapted to being connected to or being disconnected from the device, wherein the first connectors are adapted to being connected to and in electrical connection with the plurality of second connectors or being removed therefrom, wherein the plurality of patch cables are adapted to being connected to or removed from the one or more adapters, wherein each of the plurality of third connectors has an assigned corresponding connector among the plurality of patch cables, wherein the plurality of patch cables are adapted to being connected to and in electrical connection with the plurality of third connectors or being removed therefrom.

2. The system of claim 1, wherein the device is a network switch.

3. The system of claim 2, further comprising a network, wherein the network is in electrical communication with the network switch.

4. The system of claim 1, wherein the first connectors are of female configuration.

5. The system of claim 1, wherein the second connectors are of male configuration.

6. The system of claim 1, wherein the third connectors are of female configuration.

7. The system of claim 1, wherein the patch cables are of male configuration.

8. The system of claim 1, wherein the adapter is attached to the device, wherein the first connectors are connected to and in electrical connection with the plurality of second connectors, wherein the plurality of patch cables are connected to the adapter, wherein the plurality of patch cables are connected to and in electrical connection with the plurality of third connectors.

9. The system of claim 1, wherein there is one adapter.

10. The system of claim 1, wherein there are two adapters.

11. The system of claim 1, wherein the array of first connectors and the adapter are linear.

12. The system of claim 1, wherein the array of first connectors and the adapter are circular.

13. The system of claim 11, wherein the plurality of patch cables is routed from above the adapter.

14. The system of claim 11, wherein the plurality of patch cables is routed from below the adapter.

15. The system of claim 11, wherein the plurality of patch cables is routed from above and below the adapter.
